(19) United States
(12) Patent Application Publication
(10) Pub. No.: US 2024/0142109 A1
(43) Pub. Date: May 2, 2024

(54) INDUCTION HOB

(71) Applicant: Miele & Cie. KG, Guetersloh (DE)

(72) Inventors: Meike GARBEN, Roedinghausen (DE); Frank HOLTMANN, Hiddenhausen (DE); Alexander AUELL, Bielefeld (DE); Lukas Henry KRAEMER, Bielefeld (DE); Gerhard WEUSTHOF, Schapen (DE)

(21) Appl. No.: 18/496,963

(22) Filed: Oct. 30, 2023

(30) Foreign Application Priority Data
Nov. 2, 2022 (DE) 10 2022 128 975.3

(51) Int. Cl. F24C 15/00; H05B 6/12

(52) U.S. Cl. CPC F24C 15/006; H05B 6/1209

(57) ABSTRACT

An induction hob includes: a cover plate having at least one cooking area; a holding plate arranged parallel to the cover plate; at least one inductive heating coil arranged in an intermediate space between the cover plate and the holding plate; at least one electronics housing having electronics for the heating coil, which at least one electronics housing is arranged on a side of the holding plate facing away from the heating coil; a lower casing that delimits the induction hob at a bottom thereof; and at least one fan by which a cooling air flow for cooling the electronics is generatable in the lower casing. The at least one electronics housing is arranged in the lower casing, which is open at a top thereof, the holding plate covering the lower casing in an essentially airtight manner.

### CROSS-REFERENCE TO PRIOR APPLICATION

Priority is claimed to German Patent Application No. DE 10 2022 128 975.3, filed on Nov. 2, 2022, the entire disclosure of which is hereby incorporated by reference herein.

### FIELD

The invention relates to an induction hob.

### BACKGROUND

Such induction hobs are already known from the prior art in a plurality of different embodiments and comprise a cover plate having at least one cooking area, a holding plate arranged parallel to the cover plate, at least one inductive heating coil arranged in an intermediate space between the cover plate and the holding plate, at least one electronics housing having electronics for the heating coil, which electronics housing is arranged on a side of the holding plate facing away from the heating coil, and a lower casing that delimits the induction hob at the bottom, wherein the electronics housing having the electronics is arranged in the lower casing, which is open at the top, and the holding plate covers the lower casing in an essentially airtight manner, and wherein the induction hob has at least one fan by means of which a cooling air flow for cooling the electronics can be generated in the lower casing.

As examples of the existing prior art, reference is made here to the documents DE 10 2020 121 633 A1 and DE 10 2012 219 040 A1.

### SUMMARY

In an embodiment, the present invention provides an induction hob, comprising: a cover plate having at least one cooking area; a holding plate arranged parallel to the cover plate; at least one inductive heating coil arranged in an intermediate space between the cover plate and the holding plate; at least one electronics housing having electronics for the heating coil, which at least one electronics housing is arranged on a side of the holding plate facing away from the heating coil; a lower casing that delimits the induction hob at a bottom thereof; and at least one fan by which a cooling air flow for cooling the electronics is generatable in the lower casing, wherein the at least one electronics housing is arranged in the lower casing, which is open at a top thereof, the holding plate covering the lower casing in an essentially airtight manner, wherein a particular inlet opening in the lower casing is assigned to each fan of the at least one fan, and wherein, in a region of the inlet opening, a particular air duct is arranged in the lower casing such that ambient air from an environment of the induction hob is guidable through the particular inlet opening via the corresponding air duct by the particular fan so that a guided cooling air flow of ambient air is provided for each fan and is carried out by a heat sink located behind the particular fan.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 a cross-section of a side view of an embodiment of an induction hob according to the invention;

FIG. 2 a rear view of the embodiment of the induction hob according to the invention; and

FIG. 3 a front view of the exemplary embodiment of the induction hob according to the invention.

### DETAILED DESCRIPTION

In an embodiment, the present invention provides an improved induction hob, in particular an induction hob having improved cooling of the electronics.

In an embodiment, the present invention provides an induction hob comprising a cover plate having at least one cooking area, a holding plate arranged parallel to the cover plate, at least one inductive heating coil arranged in an intermediate space between the cover plate and the holding plate, at least one electronics housing having electronics for the heating coil, which electronics housing is arranged on a side of the holding plate facing away from the heating coil, and a lower casing that delimits the induction hob at the bottom, wherein the electronics housing having the electronics is arranged in the lower casing, which is open at the top, and the holding plate covers the lower casing in an essentially airtight manner, and wherein the induction hob has at least one fan by means of which a cooling air flow for cooling the electronics can be generated in the lower casing, wherein an inlet opening in the lower casing is assigned to each fan of the induction hob, wherein, in the region of the inlet opening, an air duct is arranged in the lower casing in such a way that ambient air from an environment of the induction hob is guided through the respective inlet opening via the corresponding air duct by the fan, so that a guided cooling air flow of ambient air is provided for each fan and is carried out by a heat sink located behind the respective fan.

An advantage that can be achieved with the invention is in particular that an induction hob is improved. Based on the embodiment of the induction hob according to the invention, temperature management in the induction hob is substantially improved in a structurally simple manner, for example without complicated and thus cost-intensive thermal insulation or cooling. This applies in particular to induction hobs intended for the North American market, i.e., for the USA or Canada, because for such induction hobs the lower casing must necessarily be in the form of what is known as a plastic collection tray. This plastic collection tray should catch molten plastic in the event of a fire so that it cannot flow out of the induction hob. Such a lower casing additionally makes the aforementioned temperature management more difficult in these induction hobs. The general installation situation of induction hobs in a closed bottom cabinet of kitchen furniture also has a hindering effect on temperature management. The invention provides a remedy for this. In particular, the provision of a guided cooling air flow for each fan results in a particularly strong cooling effect because the air sucked in by the fan has previously not been heated, or almost not heated, by the induction hob.

Preferably, the lower casing of the induction hob according to the invention is in the form of a plastic collection tray. The efficient guidance of the cooling air flow according to the invention is particularly advantageous for such a lower casing because hot air can accumulate in such an lower casing.

For the purposes of the invention, the guided cooling air flow is guided in that there is substantially no dead volume for the air, so that essentially no air heated by the induction hob forms part of the cooling air flow, but only sucked-in ambient air is guided directly through the respective air duct to the fan and contributes to the cooling air flow. In this case, the cooling air flow contributes to cooling the heat sink and thereby helps in that the electronics of the induction hob do not exceed a limit temperature provided for safety reasons.

In principle, the induction hob according to the invention is freely selectable within wide suitable limits as regards type, mode of operation, dimensions, material and arrangement. For example, the induction hob according to the invention may be designed as a household hob or as a commercial hob, i.e., a hob for professional use.

Preferred embodiments of the induction hob according to the invention are described below.

In a preferred embodiment of the induction hob according to the invention, the particular air duct between the inlet opening and the fan defines a duct cross-sectional area through which the cooling air flow can flow, wherein the duct cross-sectional area is less than 50 cm², in particular less than 40 cm², particularly preferably less than 25 cm². Such a small duct cross-sectional area enables a particularly short residence time of air from the guided cooling air flow within the induction hob. As a result, the guided cooling air flow is essentially not preheated by the induction cooking surface and can thereby cool particularly efficiently.

In a preferred variant of the preceding embodiment, the duct cross-sectional area has a maximum width of at most 10 cm, in particular of at most 8 cm, preferably of at most 6 cm. An air duct geometry having such a small width enables a particularly fast guidance of the guided cooling air flow to the heat sink behind the at least one fan. Compared to wider air ducts, the ambient air is supplied to the heat sink particularly quickly for the same fan output. As a result, essentially no heating of the cooling air flow takes place until the heat sink is reached.

In a further embodiment, the particular air duct is integrally formed in the lower casing. As a result, the air duct can be realized in a particularly simple manner in terms of design and production.

In a further embodiment, the cooling air flow is guided behind the heat sink to a particular outlet opening of the lower casing. The particular outlet opening is preferably uniquely assigned to a particular fan of the induction hob. A directed cooling air flow can thus be ensured starting from the particular inlet opening up as far as the outlet opening in this embodiment. Alternatively, in one embodiment according to the invention, a single outlet opening can be provided for a plurality of cooling air flows of a plurality of fans.

In a variant of the preceding embodiment, the at least one outlet opening is arranged on a side of the lower casing opposite the at least one inlet opening. This arrangement allows for particularly simple air guidance of the cooling air flow. In particular, by means of such an arrangement, bends in the air guidance can be largely avoided, as a result of which a rapid flow of the guided cooling air flow is further supported.

In a further variant, an air guide plate for homogenizing a temperature in the interior of the lower casing is arranged in the region of the at least one outlet opening on an outer side of the lower casing. As a result, the temperature in the lower casing can thereby be homogenized in a simple manner in terms of design and production technology. In the aforementioned housed-in operation, for example for the North American market, the induction hob is usually housed in a completely airtight manner so that the air of the cooling air flow can only circulate within a housing of the lower casing assigned to the particular fan. There is therefore no air exchange with the free environment outside the housing. Without the aforementioned air guide duct, very high temperatures in one of the fans could not be excluded at the same time as very moderate temperatures in the other fans due to the structural conditions of the induction hob according to the invention. This variant provides a remedy for this.

In a preferred example of the preceding variant, the air guide plate is arranged at an angle relative to the lower casing such that the cooling air flow exiting at the at least one outlet opening is backscattered to the outside of the lower casing after hitting the air guide plate. In this embodiment, the homogenization of the temperature in the lower casing is supported particularly efficiently. The direct backscattering of the exiting cooling air flow thus results in a cooling effect that is distributed over a certain region of the outside of the lower casing.

In this case, the air guide plate preferably has a plurality of outflow openings for homogenizing the exiting cooling air flow in the region of the air guide plate. The outflow openings can support a uniform distribution of the exiting cooling air flow between the air guide plate and the outside of the lower casing. In particular, they can prevent an accumulation of escaping air in certain regions between the air guide plate and the outside of the lower casing. Preferably, a plurality of regions of outflow openings are provided in the air guide plate. Preferably, a particular region of outflow openings is provided in the region of a particular outlet opening of the lower casing. In an alternative or supplementary example, at least one outflow opening of the plurality of outflow openings can be designed differently from the other outflow openings. For example, one or more outflow openings can be gap-shaped, circular, elliptical, square, rectangular or the like.

In a preferred embodiment, at least 2 fans, preferably at least 3 fans, are arranged within the lower casing and suck in a particular guided cooling air flow via a particular air duct and a particular inlet opening. In this embodiment, the cooling air flow guided according to the invention is particularly advantageous because each fan sucks in air from the environment of the induction hob via a separate air duct and, as a result, ambient air that has not yet been preheated in each fan is very quickly made available for further guidance into the respective heat sink. In this way, a particularly reliable cooling of the electronics of the induction hob can be made possible. Typically, a plurality of fans are provided in induction hobs having more than 2 cooking areas. As a result of the arrangement according to this embodiment, the solution according to the invention to the problem mentioned at the outset is extended to induction hobs having any number of cooking areas and a corresponding plurality of fans.

In a further preferred embodiment, at least one air chamber is arranged between the lower casing having the electronics on the one side and the holding plate on the other side, wherein the air chamber extends parallel to the holding plate essentially over the entire clear surface area of the lower casing. Such an air chamber acts in a thermally insulating manner and thereby supports the cooling of the electronics in the lower casing. In addition, the thermal insulation used in the prior art, usually formed from glass fiber materials, is more difficult to handle due to personal protection measures during installation. In a preferred variant of this embodiment, the at least one air chamber is essentially hermetically sealed to form a permeable remainder of the induction hob. This advantageously supports the thermally insulating effect of the at least one air chamber. An advantageous variant of this embodiment of the induction hob according to the invention also provides that the at least one air chamber is essentially hermetically sealed off from the permeable remainder of the induction hob by means of at least one intermediate plate, preferably by means of the holding plate. In this way, the at least one air chamber can be realized in a particularly simple manner in terms of design and production.

Preferably, the lower casing and/or the air guide plate are made of galvanized steel or aluminum. This makes it possible to produce the induction hob according to the invention in a simple manner. In addition, these materials have thermal properties that are advantageous for use according to the invention.

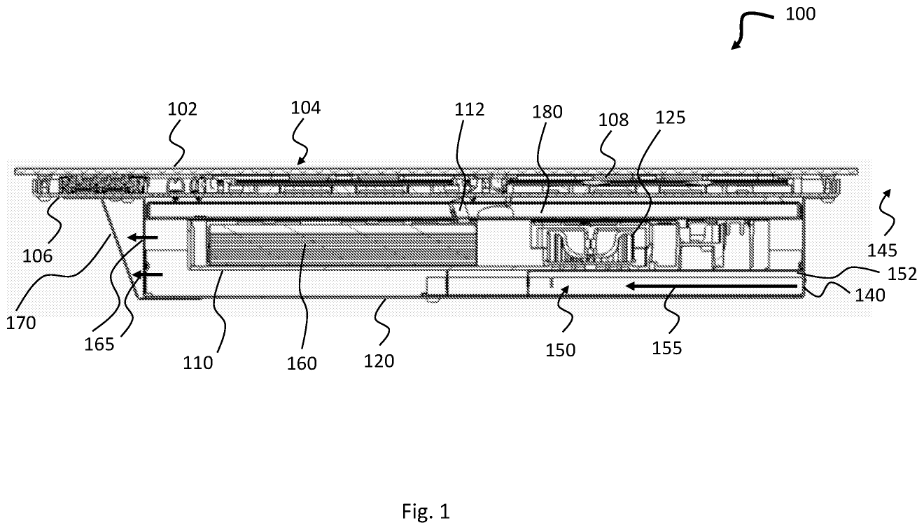

FIGS. 1 to 3 show an exemplary embodiment of an induction hob 100 according to the invention purely by way of example.

FIG. 1 shows a cross-section of a side view of the exemplary embodiment of the induction hob 100 according to the invention.

The induction hob 100 is designed for domestic use and comprises a glass ceramic cover plate 102 having a plurality of cooking areas 104. A holding plate 106 is arranged parallel to the cover plate 102, and a plurality of inductive heating coils 108 are located in an intermediate space between the cover plate 102 and the holding plate. Furthermore, the induction hob 100 comprises at least one electronics housing 110 having electronics 112 for the heating coils 108, which electronics housing is arranged on a side of the holding plate 106 facing away from the heating coils 108, and a lower casing 120 that delimits the induction hob 100 at the bottom, wherein the electronics housing 110 having the electronics 112 is arranged in the lower casing 120, which is open at the top, and the holding plate 106 covers the lower casing 120 in an essentially airtight manner. In this case, the induction hob 100 has a total of three fans, but only one fan 125 is shown in FIG. 1. A cooling air flow 155 for cooling the electronics 112 can be generated in the lower casing 120 by means of a particular fan. The cooling air flow 155 is symbolized by a solid black arrow in FIG. 1. The cooling air flow 155 can only be guided in the lower casing 120. In the present exemplary embodiment, the cooling air flow 155 is guided both in the lower casing 120 and in the electronics housing 110 arranged in the lower casing 120. The fan 125 is arranged in the electronics housing 110. FIGS. 1 to 3 only explicitly show the fan 125, but the other fans are also installed in the electronics housing 110 analogously thereto.

The dimensional stability of the holding plate 106 is very important for the operation of the induction hob 100 because good contact of the inductive heating coils 108 on the cover plate 104 of the induction hob 100 is required for a sufficiently good inductive coupling between the inductive heating coils 108 of the induction hob 100 on the one hand and a non-illustrated induction cooking utensil placed on one of the cooking areas 104 of the induction hob 100 on the other hand. Corresponding structural measures or components for ensuring the dimensional stability of the holding plate 106 in any operating state of the induction hob 100 are known to the person skilled in the art. Depending on the requirements of the individual case, the person skilled in the art will select suitable measures to achieve the dimensional stability of the holding plate 106.

The present induction hob 100 is designed to be suitable for the North American market, i.e., for the USA or Canada. Accordingly, the lower casing 120 is necessarily designed as a what is known as a plastic collection tray. This plastic collection tray should catch molten plastic in the event of a fire so that it cannot flow out of the induction hob 100.

According to the invention, a particular inlet opening 140 in the lower casing is assigned to each fan 125 of the induction hob 100. In this case, in the region of the inlet opening, a particular air duct 150 is arranged in the lower casing 120 in such a way that ambient air 145 from an environment of the induction hob 100 is guided through the particular inlet opening 140 via the corresponding air duct 150 by the respective fan 125, so that a guided cooling air flow 155 of ambient air is provided for each fan 125 and is carried out by a heat sink 160 located behind the particular fan 125.

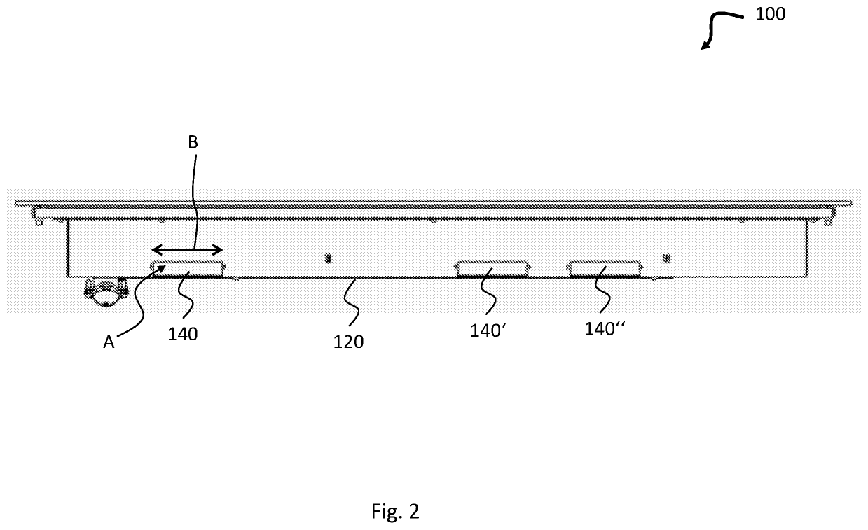

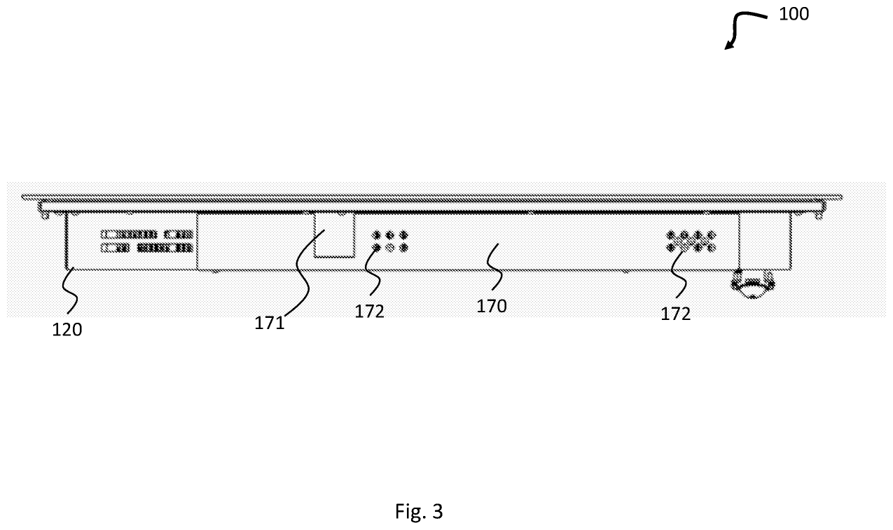

Although only one air duct 150 is shown in FIG. 1, the overall view of the other FIGS. 2 and 3 shows that the induction hob 100 has two further air ducts, so that three separately guided cooling air flows 155 are provided to cool the electronics 112 of the induction hob 100. At least in the region of the inlet opening 140, the air duct 150 is formed by an air duct element 152 arranged on the lower casing 120. This results in a duct cross-sectional area A, which is rectangular in the present case, as shown in FIG. 2. In the present case, the duct cross-sectional area A is less than 50 cm² in particular less than 40 cm², preferably less than 25 cm². In an exemplary embodiment of the induction hob according to the invention, the particular air duct is integrally formed in the lower casing.

The above-described geometry of the air guidance of the cooling air flow 155 results in rapid intake of the ambient air 145. The volume of the air present in the air duct is particularly low, so that hardly any air from the cooling air flow 155 is preheated by the induction hob 100. If a user uses the induction hob 100, in particular one of the cooking hobs assigned to the fan 125, this fan 125 is activated and sucks in almost exclusively ambient air 145 that has not been preheated by the induction hob 100 through the particular inlet opening 140. This air passes through the short and narrow air duct 150 to be available directly through the fan 125 to the heat sink 160 to cool the electronics 112. Behind the heat sink 160, the cooling air flow 155 is guided out of the lower casing 120 via at least one outlet opening 165. In this case, in the present exemplary embodiment, an air guide plate 170 is arranged on an outside of the lower casing 120 to homogenize a temperature in the interior of the lower casing 120. The cooling air flow 155, which leaves the lower casing 120 via the outlet opening 165, is in this case backscattered back via the air guide plate 170 to the lower casing 120 in order to further cool said lower casing. In the present case, the air guide plate 170 enables at least a lateral exit for the remainder of the original cooling air flow 155. In the present case, two outlet openings 165 are provided on the lower casing 120 for better dissipation of the cooling air flow 155.

In the exemplary embodiment shown, the at least one outlet opening 165 is arranged on a side of the lower casing 120 opposite the at least one inlet opening 140. In addition, there is a particular outlet opening 165 for all three fans 125 of the induction hob 100, so that the corresponding cooling air flows 155 for cooling the electronics 112 of different cooking hobs are spatially separated from one another and can only come into contact with one another as a result of the scattering on the air guide plate 170.

In the exemplary embodiment shown, in contrast to other exemplary embodiments of the induction hob according to the invention, there is a further measure for cooling the electronics 112. In the present case, at least one air chamber 180 is arranged between the lower casing 120 having the electronics 112 on the one side and the holding plate 106 on the other side, wherein the air chamber 180 extends parallel to the holding plate 106 substantially over the entire clear surface area of the lower casing 120. As a result, an additional insulation layer is introduced that reduces heat transfer.

The induction hob 100 is shown in FIG. 1 in its installation position in a bottom cabinet of kitchen furniture.

FIG. 2 shows a rear view of the exemplary embodiment of the induction hob 100 according to the invention.

The illustrated view clearly shows the three inlet openings 140, 140′, 140″ of the induction hob 100. Two inlet openings 140′, 140″ are arranged next to each other. The cooling air flow guided via the respective inlet opening 140, 140′, 140″ is spatially separated from each of the two other cooling air flows within the lower casing 120.

Furthermore, FIG. 2 shows the maximum duct cross-sectional area A of the air duct. The air duct is not wider than the particular inlet opening 140, 140′, 140″. The duct cross-sectional area has a maximum width B of at most 10 cm, in particular of at most 8 cm, particularly preferably of at most 6 cm.

FIG. 3 shows a front view of the exemplary embodiment of the induction hob 100 according to the invention.

The outlet openings of the induction hob 100 are not discernible in this view due to the air guide plate 170.

The air guide plate 170 is arranged only in the region of the outlet openings, so that it does not extend over the entire width of the induction hob 100.

For air guidance, the air guide plate 170 has a recess 171 and a plurality of outflow openings 172 for homogenizing the exiting cooling air flow in the region of the air guide plate 170. As a result, homogenization of the temperature within the lower casing 120 of the induction hob 100 can be achieved. The outflow openings 172 are round in the illustrated embodiment. Alternatively or additionally, the outflow openings can be elliptical, angular, gap-shaped or the like. The plurality of outflow openings 172 are preferably positioned on the basis of flow-dynamic simulations for determining the most effective possible homogenization of the temperature within the lower casing 120 of the induction hob 100.

Due to the induction hob 100 according to the invention according to the present embodiment, temperature management in the induction hob 100 is thus substantially improved in a structurally simple manner, namely without a complicated and thus cost-intensive thermal insulation or cooling. This is particularly true because the induction hob 100 is an induction hob for the North American market, i.e., for the USA or Canada. Accordingly, the lower casing 120 is necessarily designed as a what is known as a plastic collection tray. This plastic collection tray is intended to catch molten plastic in the event of a fire so that it cannot flow out of the induction hob 100. In addition, the insulation used in the prior art, usually formed from glass fiber materials, is effectively replaced by the air chamber due to personal protection measures during installation.

The invention is not limited to the present exemplary embodiment. For example, the invention can also be advantageously used in induction hobs for commercial operation, i.e., for professional use. This also applies to induction hobs, which, in contrast with those intended for the North American market, do not require a special lower casing, i.e., a plastic collection tray. In contrast to the present exemplary embodiment, embodiments of the invention are also conceivable in which only one air chamber and/or less than three fans or a plurality of air chambers and/or more than three fans is/are installed. The same applies to the number of air ducts. Furthermore, the at least one air duct, if present, can be designed as a one-piece air duct. In the case of a multi-piece air duct, other detachable or non-detachable connecting techniques than the plug-in or adhesive connection used in the present embodiment are also conceivable.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

100 Induction hob
102 Cover plate
104 Cooking area
106 Holding plate
108 Inductive heating coil
110 Electronics housing
112 Electronics
120 Lower casing
125 Fan
140, 140′, 140″ Inlet opening
145 Ambient air
150 Air duct
155 Cooling air flow
160 Heat sink
165 Outlet opening
170 Air guide plate
171 Recess
172 Outflow openings
180 Air chamber
A Duct cross-sectional area
B Maximum width of the duct cross-sectional area

1. An induction hob, comprising:
a cover plate having at least one cooking area;
a holding plate arranged parallel to the cover plate;
at least one inductive heating coil arranged in an intermediate space between the cover plate and the holding plate;
at least one electronics housing having electronics for the heating coil, which at least one electronics housing is arranged on a side of the holding plate facing away from the heating coil;
a lower casing that delimits the induction hob at a bottom thereof; and
at least one fan by which a cooling air flow for cooling the electronics is generatable in the lower casing,
wherein the at least one electronics housing is arranged in the lower casing, which is open at a top thereof, the holding plate covering the lower casing in an essentially airtight manner,
wherein a particular inlet opening in the lower casing is assigned to each fan of the at least one fan, and
wherein, in a region of the inlet opening, a particular air duct is arranged in the lower casing such that ambient air from an environment of the induction hob is guidable through the particular inlet opening via the corresponding air duct by the particular fan so that a guided cooling air flow of ambient air is provided for each fan and is carried out by a heat sink located behind the particular fan.

2. The induction hob of claim 1, wherein the particular air duct between the inlet opening and the fan defines a duct cross-sectional area through which the cooling air flow is flowable, and
wherein the duct cross-sectional area is less than 50 cm².

3. The induction hob of claim 2, wherein the duct cross-sectional area has a maximum width of at most 10 cm.

4. The induction hob of claim 1, wherein the respective air duct is integrally formed in the lower casing.

5. The induction hob of claim 1, wherein the cooling air flow is guidable behind the heat sink to a particular outlet opening of the lower casing.

6. The induction hob of claim 5, wherein at least one outlet opening is arranged on a side of the lower casing opposite at least one inlet opening.

7. The induction hob of claim 5, wherein an air guide plate configured to homogenize a temperature in an interior of the lower casing is arranged in a region of at least one outlet opening on an outer side of the lower casing.

8. The induction hob of claim 7, wherein the air guide plate is arranged at an angle relative to the lower casing such that cooling air flow exiting at at least one outlet opening is backscattered to an outside of the lower casing after hitting the air guide plate.

9. The induction hob of claim 7, wherein the air guide plate has a plurality of outflow openings configured to homogenize exiting cooling air flow in a region of the air guide plate.

10. The induction hob of claim 1, wherein the at least one fan comprises at least two fans, and
wherein the at least two fans are arranged within the lower casing and are configured to suck in a particular guided cooling air flow via a particular air duct and a particular inlet opening.

11. The induction hob of claim 1, wherein at least one air chamber is arranged between the lower casing having the electronics on one side and the holding plate on an other side, and
wherein the air chamber extends parallel to the holding plate essentially over an entire clear surface area of the lower casing.

12. The induction hob of claim 2, wherein the duct cross-sectional area is less than 40 cm².

13. The induction hob of claim 12, wherein the duct cross-sectional area is less than 25 cm².

14. The induction hob of claim 3, wherein the maximum width is at most 8 cm.

15. The induction hob of claim 14, wherein the maximum width is at most 6 cm.

16. The induction hob of claim 10, wherein the at least two fans comprises at least three fans.
